(19) United States
(12) Patent Application Publication
(10) Pub. No.: US 2024/0344212 A1
(43) Pub. Date: Oct. 17, 2024

(54) RECOMBINATION LAYERS FOR CROSSOVER MITIGATION FOR EXCHANGE MEMBRANES AND WATER ELECTROLYZER MEMBRANE ELECTRODE ASSEMBLIES

(71) Applicant: Plug Power Inc., Latham, NY (US)

(72) Inventors: Cortney MITTELSTEADT, Latham, NY (US); Qiang SUN, Latham, NY (US); Fan YANG, Latham, NY (US)

(73) Assignee: Plug Power Inc., Latham, NY (US)

(21) Appl. No.: 18/476,995

(22) Filed: Sep. 28, 2023

Related U.S. Application Data
(60) Provisional application No. 63/496,135, filed on Apr. 14, 2023.

(51) Int. Cl. C25B 9/23; C25B 1/04; C25B 11/042; C25B 13/02; C25B 13/08

(52) U.S. Cl. CPC C25B 9/23; C25B 1/04; C25B 11/042; C25B 13/02; C25B 13/08

(57) ABSTRACT

A method for forming a recombination layer includes, for example, an ionomer and a nanocrystal catalyst disposed in the ionomer. A method for forming the recombination layer may include, for example, providing an ionomer dispersion, providing a compound having a catalyst having a charge, adding the catalyst in the compound to the ionomer to form a mixture, reducing the catalyst in the compound to a metal catalyst in the ionomer, and forming the mixture with the metal catalyst into a recombination layer for a proton exchange membrane.

### CROSS-REFERENCE TO RELATED APPLICATIONS

This application claims priority benefit under Section 35 U.S.C. § 119 (e) of U.S. Provisional Application No. 63/496,135 filed Apr. 14, 2023, entitled, “Recombination Layers For Crossover Mitigation For Exchange Membranes And Water Electrolyzer Membrane Electrode Assemblies,” which is incorporated herein by reference in its entirety.

This application is related to commonly assigned, co-pending patent application Ser. No. 17/590,969, filed on Feb. 2, 2022, entitled “Proton Exchange Membrane Water Electrolyzer Membrane Electrode Assembly” (atty. dock. no. 1404.313A), which is hereby incorporated herein by reference in its entirety.

This application is related to commonly assigned, co-pending patent application Ser. No. 17/590,971, filed Feb. 2, 2022, entitled “Proton Exchange Membrane Water Electrolyzer Membrane Electrode Assembly” (atty. dock. no. 1404.313B), which is hereby incorporated herein by reference in its entirety.

### TECHNICAL FIELD

The present disclosure relates generally to proton exchange membrane water electrolyzer membrane electrode assemblies (MEAs), and more particularly, recombination layers or ionomer dispersions for crossover mitigation for use in proton exchange membranes and water electrolyzer MEAs.

### BACKGROUND

The utilization of renewable energy has driven substantial investments into water electrolysis technologies. It is estimated that the water electrolysis market could increase to 300 GW over the next two decades, and power-to-gas is poised to become a multi-billion-dollar market for on-site electrolyzer systems over the next decade.

A proton exchange membrane (PEM) electrolysis cell is a device which produces hydrogen and oxygen gas by using DC electricity to electrochemically split water. A PEM cell contains an “active area” in which the presence of catalyst promotes the reactions to take place. In the electrolysis cell, the water enters the anode and is split into protons, electrons, and oxygen gas. The protons are conducted through the membrane while the electrons pass through the electrical circuit. At the cathode, the protons and electrons recombine to form hydrogen gas. The electrolysis half-reactions are shown below.

$$2 {H}_{2} O \to 4 {H}^{+} + 4 {e}^{-} + {O}_{2} \\ 4 {H}^{+} + 4 {e}^{-} \to 2 {H}_{2}$$

FIG. 1A illustrates a prior art dry build process 10 for use in forming a recombination layer for a proton exchange membrane of a water electrolyzer MEA. In the process, initially at block 20, a Pt doped ionomer dispersion is prepared which takes approximately hours to days. At block 30, the prepared Pt doped ionomer dispersion is cast into thin membrane on anode decal of approximately 1 mil for a roll-to-roll process. Thereafter, at block 40, the membrane on the anode decal is ready for dry lamination in about 3 minutes.

As shown in FIG. 1B, prior art block 20 (FIG. 1) includes at block 21, weighing 4 grams of Pt black and 0.095 grams Ce(OH)₄, which at block 23 is added to ZrO₂ mixing beads in a container. The Pt black is a metal in which the platinum metal has no charge. At block 25, the container is purged with inert gas and 1,000 grams of perfluorinated sulfonic-acid (PFSA) ionomers (e.g., Nafion®, 3M™, Aquivion™ FORBLUE™, Donyue™, Hyproof™, Thinkre™, etc.) are poured and added to the container. The inert gas prevents the chemically active platinum from catching fire with the ionomer and burning. At block 27, the contents of the container is milled for 7 to 14 days. Thereafter, at block 29, the contents of the container is applied as a top coat or recombination layer in a roll-to-roll process onto an anode decal with substrate, such as ETFE or a Kapton. Typically, a 1 mil recombination layer and a 2-mil membrane layer are laminated to form a proton exchange membrane.

The process is time-consuming and labor-intensive. The resulting recombination layer has a low efficiency to mitigate hydrogen crossover. Most of the platinum is oxidized by high voltage on the anode and platinum oxide is not efficient in mitigating hydrogen crossover. There is also an excess of platinum in that platinum black is randomly dispersed into the ionomer dispersion in the form of aggregation so the utility of Pt active sites is low.

FIG. 2 illustrates a prior art process 50 for use in forming a proton exchange membrane for a water electrolyzer MEA. In the process, initially at block 52 a Nafion® 115 membrane is cut, at block 54 the membrane is boiled in deionized water, at block 56 a platinization process is employed, at block 58 a reduction process is employed, at block 60 a sulfuric acidification process is employed, and at block 62, the membrane is boiled in deionized water.

Specifically, at block 52, a piece of Nafion® 115 membrane is cut into a desired size, and at block 54 boiled in deionized water for 3.12 hours to remove any impurities and keep fully hydrated. At block 56 the platinization process includes diluting tetraamine platinum hydroxide to 0.042%-0.046%, the boiled Nafion® 115 membrane is immersed in the 2.5 L solution of tetraamine platinum hydroxide for 30 minutes, and the membrane is placed into deionized water after 30 minutes. The platinized membrane is rinsed with deionized water to remove any excess platinum solution.

At block 58, the application of the reduction process includes preparation of a solution of 14 grams of sodium hydroxide, 140 grams sodium borohydride, and 4 quarts of deionized water, the solution temperature is increased to 110° F., the platinized Nafion® 115 membrane is immersed in the solution to reduce the platinum ions to metal, and the reduced membrane is rinsed with deionized water several times to remove any excess reducing agent.

At block 60, the application of the sulfuric acidification process includes preparing a solution of 1 liter 98% sulfuric acid and 12 liters water, the reduced membrane is immersed in the sulfuric acid solution for one hour, twice, the sulfuric acid-treated membrane is rinsed with deionized water three times to remove any excess sulfuric acid. At block 62, the sulfuric acid-treated membrane is boiled in deionized water for 3.12 hours to ensure fully hydration and high proton conductivity.

Drawback with method 50 of using sodium borohydride as a reduction reagent results in sodium having a positive charge remaining in the membrane. The sodium with a positive charge is detrimental because it occupies the proton exchanger in the membrane and decreases the proton conductivity of the membrane.

Klose et al. developed an 8-mil tri-layer membrane using a spray coating containing Pt to form an interlayer between NR212 and N115 membranes. C. Klose et al 2018, Membrane Interlayer with Pt Recombination Particles for Reduction of the Anodic Hydrogen Content in PEM Water Electrolysis, J. Electrochem. Soc. 165 F1271.

### SUMMARY

Shortcomings of the prior art are overcome and additional advantages are provided through the provision of a recombination layer, which includes for example, an ionomer and a nanocrystal catalyst disposed in the ionomer.

In some embodiments, the nanocrystal catalyst is nonuniformly distributed in the ionomer, and predominantly distributed in the hydrogen and water transport channels of the ionomer. For example, the nanocrystal catalyst may be dominantly distributed in the hydrogen and water transport channels of the ionomer and isolated in the high voltage environment (larger than 1.7V), for example, an ionomer and a nanocrystal catalyst disposed in the ionomer. The nanocrystal catalyst may include platinum crystals based on a platinum salt such as tetraamine platinum hydroxide. The recombination layer may have a thickness of between 0.2 mil and 1 mil.

In another embodiment, a proton exchange membrane includes the above recombination layer, a membrane layer, a catalyst content in the recombination layer being greater or equal than a catalyst content in the membrane layer, and the proton exchange membrane having an interface between the recombination layer and the membrane layer. In some embodiments, the membrane is disposed on an anode electrode, which anode electrode is disposed on a substrate.

In another embodiment, a MEA includes the above proton exchange membrane, an anode electrode disposed on the recombination layer, and a cathode electrode disposed on the membrane layer.

In another embodiment, a method for electrolyzing water includes, for example, the providing the above MEA, and applying a voltage potential across the cathode electrode and the anode electrode to produce hydrogen.

In another embodiment, a method for forming a recombination layer includes, for example, providing an ionomer dispersion, providing a compound having a catalyst precursor having a charge, adding the compound to the ionomer to form a mixture, reducing the catalyst in the compound to a metal catalyst in the ionomer, and forming the mixture with the metal catalyst into a recombination layer for a proton exchange membrane.

In some embodiments, the reducing includes forming a nanocrystal catalyst, the adding includes nonuniformly depositing the compound in the ionomer dispersion, the nonuniformly depositing includes depositing the compound in channels of the ionomer dispersion, and the catalyst includes platinum.

In another embodiment, the method further includes, for example, forming a proton exchange membrane, which includes providing a membrane layer having a first thickness, providing the recombination layer having a second thickness, the catalyst content in the recombination layer being greater or equal than a catalyst content in the membrane layer, and forming the membrane layer and the recombination layer into a proton exchange membrane having an interface between the membrane layer and the recombination layer.

In another embodiment, the method further includes, for example, for forming a MEA, which includes providing an anode electrode, providing a cathode electrode, and forming the membrane layer, the recombination layer, the anode electrode, and the cathode electrode into a membrane electrode assembly (MEA) includes the proton exchange membrane having an interface between the membrane layer and the recombination layer.

In another embodiment, a method for electrolyzing water includes, for example, providing the above membrane electrode assembly (MEA), and applying a voltage potential across the cathode electrode and the anode electrode to produce hydrogen.

### BRIEF DESCRIPTION OF THE DRAWINGS

The subject matter which is regarded as the disclosure is particularly pointed out and distinctly claimed in the concluding portion of the specification. The disclosure, however, may best be understood by reference to the following detailed description of various embodiments and the accompanying drawings in which:

FIG. 1A is a flowchart of a prior art method for use in forming a recombination layer for a proton exchange membrane for a water electrolyzer MEA;

FIG. 1B is a flowchart of the prior art method step for preparing the platinum doped ionomer dispersion of FIG. 1;

FIG. 2 is a flowchart of a prior art method for use in forming a proton exchange membrane with recombination catalyst for a water electrolyzer MEA;

FIG. 3 is a MEA employing a recombination layer for crossover mitigation in a proton exchange membrane, along with H₂ and O₂ concentration distributions, according to an embodiment of the present disclosure;

FIG. 4 is a flowchart for forming a recombination layer for use in the water electrolyzer MEA of FIG. 3, according to an embodiment of the present disclosure;

FIG. 5 is a diagrammatic illustration of a method for casting a thin cast catalyst membrane, according to an embodiment of the present disclosure;

FIG. 6 is a diagrammatic illustration of a process for forming a proton exchange membrane with recombination layer, according to an embodiment of the present disclosure;

FIG. 7 is a diagrammatic illustration of a process for forming an anode decal, according to an embodiment of the present disclosure;

FIG. 8 is a cross-sectional view of an anode decal, according to an embodiment of the present disclosure;

FIG. 9 is a diagrammatic illustration of the recombination layer of FIG. 8, according to an embodiment of the present disclosure;

FIG. 10 is a cross-sectional view of a prior art anode decal;

FIG. 11 is a diagrammatic illustration of the prior art recombination layer of FIG. 10;

FIG. 12 is a graph of the hydrogen crossover of a prior art water electrolyzer MEA having the prior anode decal of FIG. 10;

FIG. 13 is a graph of the hydrogen crossover of the water electrolyzer membrane electrode assembly of FIG. 8;

FIG. 14 is a diagrammatic illustration of a roll-to-roll process for forming a recombination layer membrane, according to an embodiment of the present disclosure;

FIG. 15 is a diagrammatic illustration of a roll-to-roll process for forming a membrane electrode assembly employing a two-step lamination process, according to an embodiment of the present disclosure; and

FIG. 16 is a diagrammatic illustration of a roll-to-roll process for forming a membrane electrode assembly employing a one-step lamination process with the membrane electrode assembly, according to an embodiment of the present disclosure.

### DETAILED DESCRIPTION

The present disclosure is directed to hydrogen crossover mitigation design for proton exchange membranes, and for water electrolyzer membrane electrode assemblies (MEAs) employing such exchange membranes.

As will be appreciated from the description below, the forming of the recombination layer may operably tailor and preferentially distribute the platinum catalyst in the channels in an ionomer. For example, a technique of the present disclosure is directed to introducing platinum ions into a PFSA (Nafion®, 3M™, Aquivion™, FORBLUE™, Donyue™, Hyproof™, Thinkre™, etc.) polymer network and reducing them to form Pt nanocrystals. A goal is to predominantly distribute these Pt nanocrystals in the hydrogen channel of the PFSA (Nafion®, 3M™, Aquivion™, FORBLUE™, Donyue™, Hyproof™, Thinkre™, etc.) polymer network to increase the utility of the recombination layer; in the meanwhile, the Pt nanocrystal was isolated by the PFSA's (Nafion®, 3M™, Aquivion™, FORBLUE™, Donyue™, Hyproof™, Thinkre™, etc.) PTFE backbone, so it can keep at the metal state instead of being oxidized.

For example, the recombination layer may be formed by employing a compound having a catalyst that is charged, which is preferentially deposited in the hydrogen transport channels of the ionomer dispersion, and which compound having the catalyst is then operably reduced resulting in the metal catalyst such as nanocrystal catalyst disposed in the channels of the ionomer. In some embodiments, the compound may be a metal salt containing platinum such as tetraamine platinum hydroxide in which the platinum in the compound has a positive charge, and in which the platinum is reduced to form a platinum nanocrystal catalyst in the channels for the ionomer.

As will be further appreciated from the description below, present disclosure for preparing mixtures for forming recombination layers of a proton exchange membrane may be operable to improve mitigation of hydrogen crossover compared to current PEM electrolyzers, reduce Pt cost compared to the current membrane platinization process, and improve the efficiency such as performance of crossover mitigation compared to current PEM electrolyzers. The present disclosure may also allow for preparing proton exchange members and PEM eletrolyzers faster compared current PEM electrolyzers.

For example, as will be appreciated from the description below, with the hydrogen channel of the PFSA (such as Nafion®, 3M™, Aquivion™, FORBLUE™, Donyue™, Hyproof™, Thinkre™, etc.) polymer network facilitates the transportation of protons across the membrane. By placing the platinum particles predominantly distributed in the hydrogen channel of the polymer network ensures that they are in direct contact with the protons. This enhances the efficiency of the recombination process, as the protons can easily combine with the oxygen on the surface of the platinum particles.

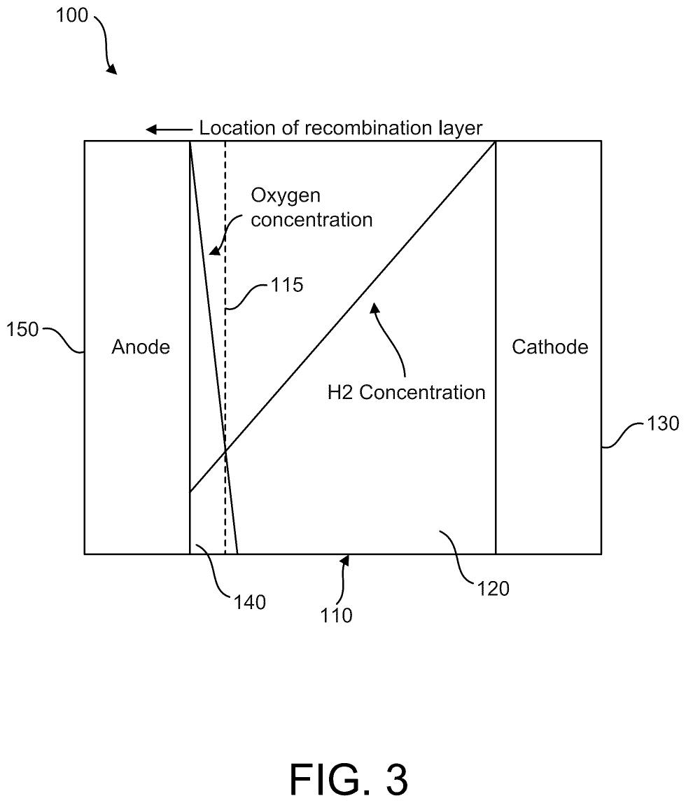

FIG. 3 illustrates a water electrolyzer MEA 100 employing a recombination layer 140 prepared, according to an embodiment of the present disclosure. For example, water electrolyzer MEA 100 may include a proton exchange membrane 110 having a cathode electrode 130, and an anode electrode 150. Ion exchange membrane 110 may include a first membrane layer 120 and recombination layer or second membrane layer 14. First membrane layer 120 has a first thickness, recombination layer or second membrane layer 140 has a thickness, and recombination layer or second membrane layer 140 contains a catalyst content that is greater or equal than a catalyst content in first membrane layer 120. First layer membrane 120, recombination layer or second layer membrane 140, cathode electrode 130, and anode electrode 150 are formed into membrane electrode assembly 100 (MEA) having a proton exchange membrane 110 with an interface 115 between first layer membrane 120 and recombination layer or second layer membrane 140. The recombination layer is disposed at the membrane/anode interface. In some embodiments, the first membrane layer may have a first thickness, the recombination layer or second membrane layer may have a thickness less than the first thickness, and the recombination layer or second membrane layer contains a catalyst content that is greater than a catalyst content in first membrane layer.

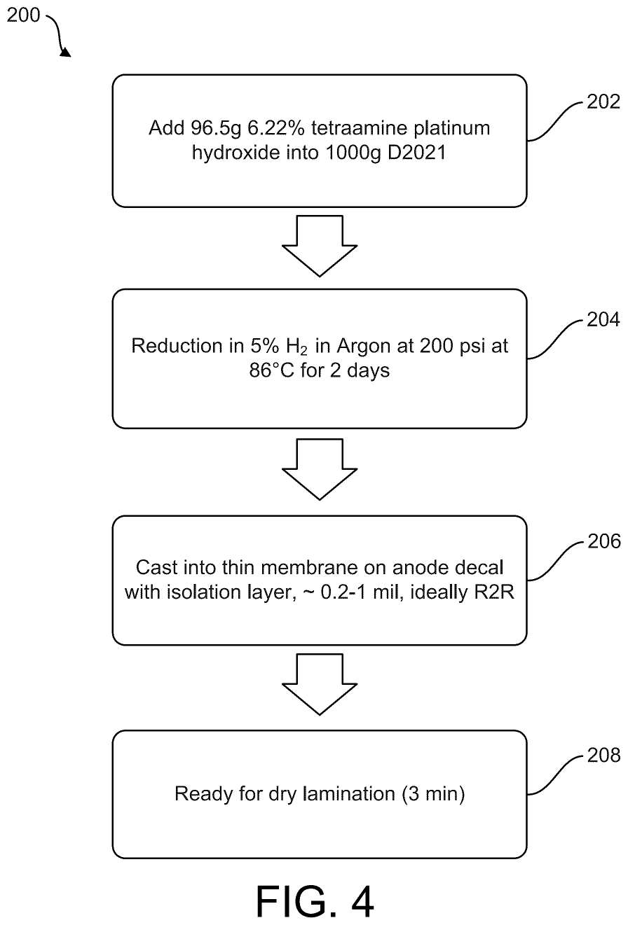

FIG. 4 illustrates a method 200 for forming recombination layer 140 (FIG. 3) in the water electrolyzer MEA 100 (FIG. 3), according to an embodiment of the present disclosure.

In this illustrated embodiment, method 200 may include, for example, at block 202, adding a compound containing a catalyst such as a platinum salt, for example, tetraamine platinum hydroxide, tetraammineplatinum (II) chloride, and/or platinum diamino dinitro nitrate to an ionomer dispersion to form a mixture.

Pt(NH₃)₄(OH)₂·xH₂O

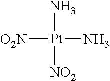

[Pt(NH₃)₄]Cl₂

For example, in tetraamine platinum hydroxide, the platinum is in its 2+ oxidative state, and the compound containing the catalyst is preferentially disposed in the channels of the ionomer dispersion as described further below. In this illustrated enablement, a ratio of 96.5 grams 6.22% tetraamine platinum hydroxide may be added into a 1,000 grams ionomer dispersion such as Nafion®, 3M™, Aquivion™, FORBLUE™, Donyue™, Hyproof™, Thinkre™, etc. to from the mixture.

At block 204, the mixture is maintained in a reduction environment such as a gas or pressurized gas to reduce the compound containing the catalyst such as platinum salt in the channels to platinum metal crystal particles with zero charge. For example, the mixture may be pressured in 5% H₂ in argon at 200 psi at 86 Celsius for about 2 days. Alternatively, the platinum salt in the mixture can be reduced to nanocrystal by being purged with 5% H₂ in argon with a constant flow rate at 86 Celsius for about 3 hours. Temperature range may be from 50 Celsius to 120 Celsius. In other embodiments, the mixture may be pressured in 5% H₂ in argon at 200 psi at 86 Celsius for about 3 days, less than about 3 days, less than about 2 days, about 1 day, less that about 1 day, about 12 hours, less that about 12 hours, about 6 hours, less that about 6 hours, less than about 3 hours, between about 3 hours and about 3 days, between about 3 hours and about 2 days, between about 3 hours and 1 day, between about 1 day and about 3 days, or other suitable time. At block 206, the mixture is cast into a thin membrane on a carrier substrate to form the recombination layer. For example, the mixture may be cast into a thin membrane on an anode decal with an isolation layer. The cast thin membrane may be about 0.2 mil to about 1 mil and may be formed using a roll-to-roll process. For example, the mixture may be then coated on a substrate such as polyimide (Kapton) film such as in a roll-to-roll process as described below. At block 208, in about 3 minutes, the cast thin recombination layer is ready for dry lamination to a membrane and/or a membrane and anode electrode, in which the membrane has no or less catalyst than the recombination layer.

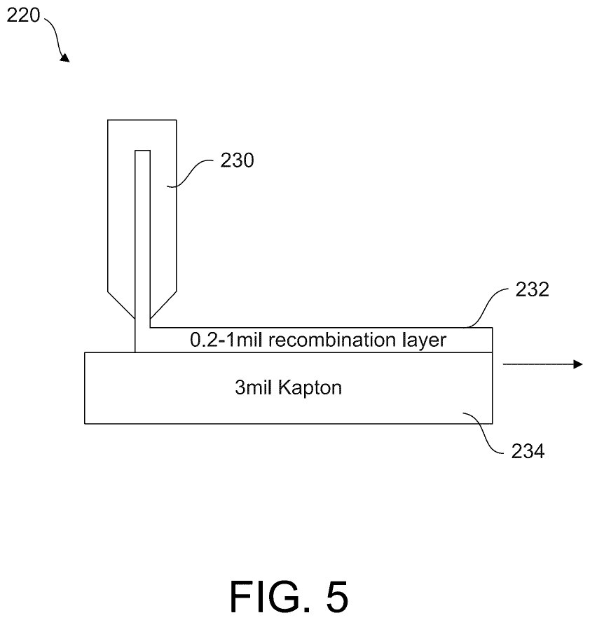

FIG. 5 diagrammatically illustrates a process 220 for casting a recombination layer 232, according to an embodiment of the present disclosure. For example, in this embodiment, a mixture may be prepared as shown in block 202 (FIG. 4) and described above such as by adding a platinum salt such as tetraamine platinum hydroxide to an ionomer dispersion, which may include 96.5 grams 6.22% tetraamine platinum hydroxide added into a 1,000 grams PFSA ionomers (Nafion®, 3M™, Aquivion™, FORBLUE™, Donyue™, Hyproof™, Thinkre™, etc.), and maintaining the mixture in a pressurized environment such as shown in block 204 (FIG. 4), which may include pressurizing the mixture in 5% H₂ in argon at 200 psi at 86 Celsius for 2 days.

For example, a depositor 230 may include a controllable flow rate and a controllable gap so that the depositor such as an injector or extruder may continuously deposit the mixture onto a moving substrate 234. Recombination layer 232 includes the ionomer with catalyst such as platinum as a metal crystal. The mixture may be deposed having a thickness of about 0.2 to about 1 mil, and the substrate may be polyimide backer film such as a 3 mil Kapton substrate. In some embodiments, process 220 may employ one-pass or multiple passes to form the thickness of the resulting recombination layer 232. In addition, each pass may contain different loading or amounts of platinum with different thickness of the deposited mixture. Other processes for forming the recombination layer may include using a doctor blade film applicator, a roll-to-roll process, or other suitable processes.

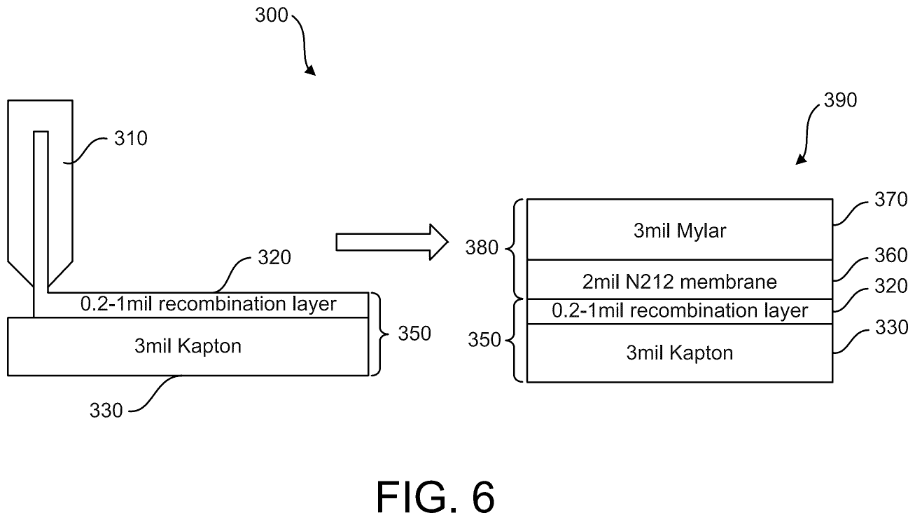

FIG. 6 diagrammatically illustrates a process 300 for forming a bi-layer proton exchange membrane 380, according to an embodiment of the present disclosure. As illustrated in FIG. 6, a mixture for forming a recombination layer 320 is deposited on a substrate as described in process 220 (FIG. 5) or other suitable processes. The cast mixture may be deposed having a thickness of about 0.2 mil to about 1 mil, and the substrate may be a 3 mil Kapton substrate.

After the cast mixture is cured or partially cured such as passing through, for example, a dryer or furnace, the recombination layer 320 and substrate 330 may be die cut and formed into a die cut structure 350 or otherwise processed to a desired shape or size. For example, die cut structure 350 may be sized based on the size of the desired MEA to be fabricated. In some embodiments, the die cut structure 350 may have a size such as a 50 cm² or 1200 cm².

A die cut second structure 380 may include a membrane layer 360, for example, not having a catalyst and a second substrate 370. Membrane layer 360 may be a 2 mil membrane made from PFSA (Nafion®, 3M™, Aquivion™, FORBLUE™, Donyue™, Hyproof™, Thinkre™, etc.), and second substrate 370 may be a Mylar backer such as a 3 mil mylar layer. Die cut structure 350 and die cut structure 380 may be laminated together in a hot press to form bi-layer proton exchange membrane 390. The membrane layer may have a thickness of between about 1 mil and about 3 mil, between about 1 mil and about 2 mil, between about 1.5 mil and about 2.5 mil, about 1 mil, about 2 mil, about 3 mil, or other suitable thickness.

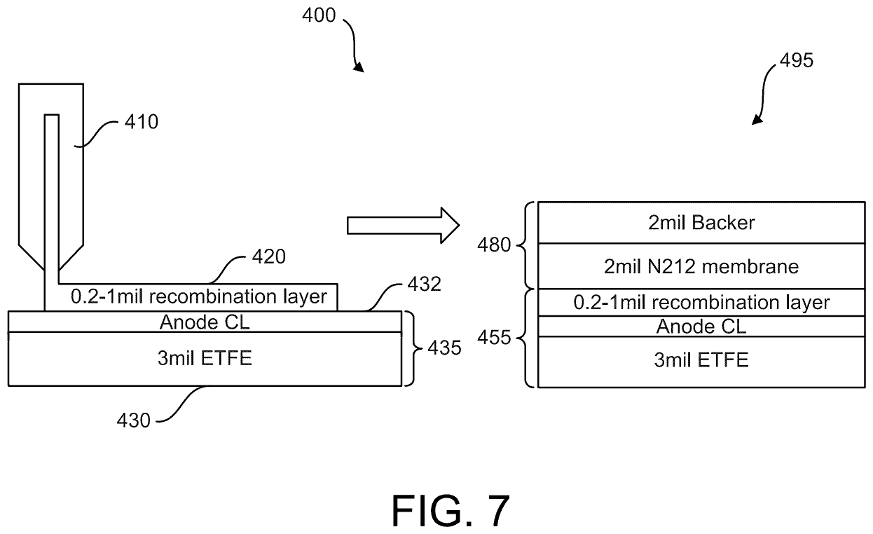

FIG. 7 diagrammatically illustrates a process 400 for forming a bi-layer proton exchange membrane coated anode decal 495, according to an embodiment of the present disclosure. As illustrated in FIG. 7, generally a mixture with a catalyst may be formed as described above in connection with FIG. 4, and bi-layer proton exchange membrane coated anode decal 495 may be formed in a lamination process.

With reference again to FIG. 7, for example, a depositor 410 such as an injector or extruder may continuously deposit a mixture forming recombination layer 420 onto a moving anode decal 435 having a substrate 430 and an anode electrode 432. The cast recombination layer 420 may include the ionomer with a catalyst such as platinum crystal as described above. The mixture may be deposed having a thickness of about 0.2 mil to about 1 mil, and the substrate may be a 3 mil Kapton substrate. In some embodiments, the thickness of the resulting recombination layer 420 may be formed with one-pass or multiple passes, or other suitable processes.

After the recombination layer is cured or partially cured on the anode electrode 432 and substrate 430 such as passing through, for example, a dryer or furnace, the recombination layer 420, anode electrode 432, and substrate 430 may be die cut and formed into a die cut structure 455 or otherwise processed to a desired shape or size. For example, die cut structure 455 may be sized based on the size of the desired MEA to be fabricated. In some embodiments, the die cut structure 455 may have a size such as a 50 cm² or 1200 cm².

A die cut membrane structure 480 may include a membrane layer 460, for example, not having a catalyst and a second substrate 470. Membrane layer 460 may be a 2 mil membrane made from PFSA (Nafion®, 3M™, Aquivion™, FORBLUE™, Donyue™, Hyproof™, Thinkre™, etc.), and second substrate 470 may be a plastic backer such as a 2 mil mylar layer. Die cut structure 455 and die cut structure 480 may be laminated together in a hot press. The membrane layer may have a thickness of between about 1 mil and about 3 mil, between about 1.5 mil and about 2.5 mil, about 1 mil, about 2 mil, about 3 mil, or other suitable thickness.

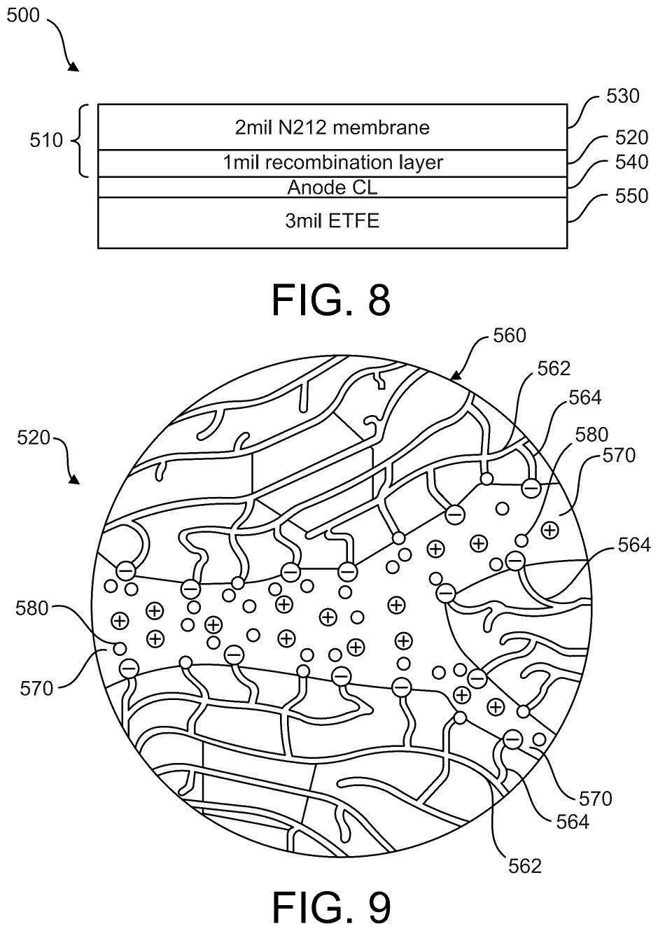

FIG. 8 illustrates a bi-layer proton exchange membrane coated anode decal 500, according to the present disclosure. For example, decal 500 may include a bi-layer proton exchange membrane 510 having a recombination layer 520 and a membrane layer 530, disposed on an anode 540 and a support 550. Bi-layer proton exchange membrane 510 may include recombination layer 520 having a nanocrystal and formed by the processes described above. Membrane layer 530 may not include a catalyst.

As diagrammatically shown in FIG. 9, recombination layer 520 includes an ionomer 560 having a network chain of a plurality of backbone chains 562 (such as PTFE, a plastic) and side chains or branches 564 (function groups with negative charge), which define channels 570 or passageways for the transfer of hydrogen protons during the electrolysis process. As shown in FIG. 9, metal catalyst 580 such as platinum nanoparticle or crystals (having a crystalline structure such as square, triangular, cubic structure with an arrangement of atoms in a crystal) is disposed primarily in the channels 570. As described above, during the forming of recombination layer 520, platinum salt is combined with the ionomer dispersion 560 resulting in the platinum salt being predominately distributed in channels 570 of the cast recombination layer 520. Specifically, after reduction of the platinum salt in a reduced gas environment, the platinum salt is converted or reduced to platinum nanocrystals 580 disposed in channels 570 of ionomer 560.

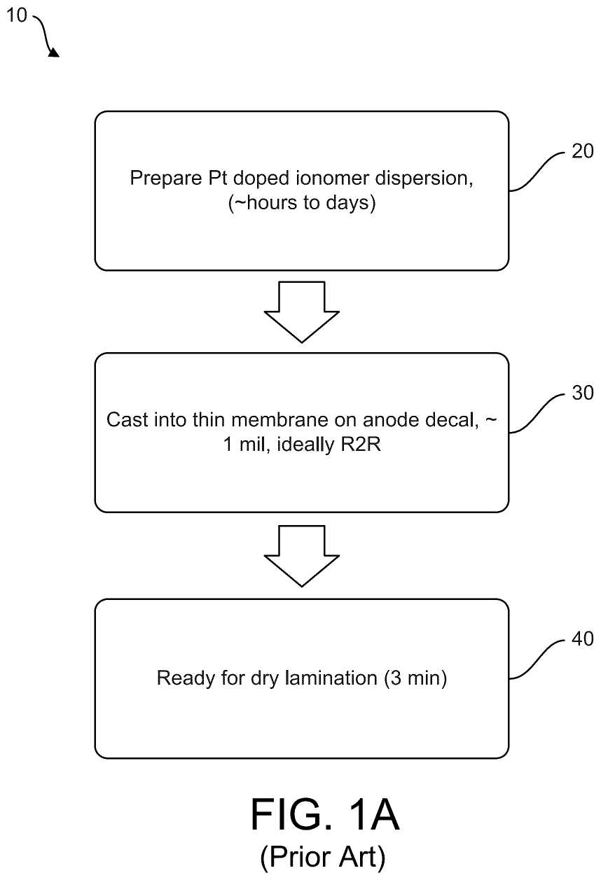

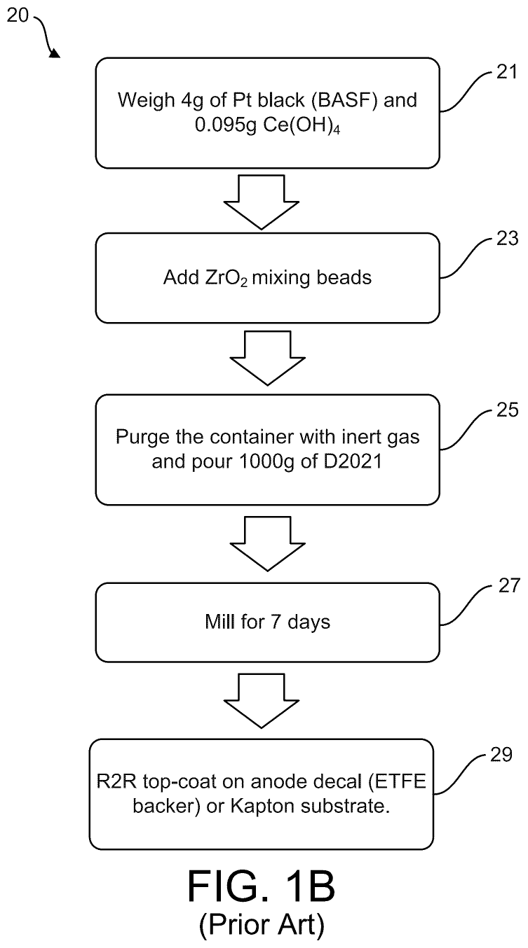

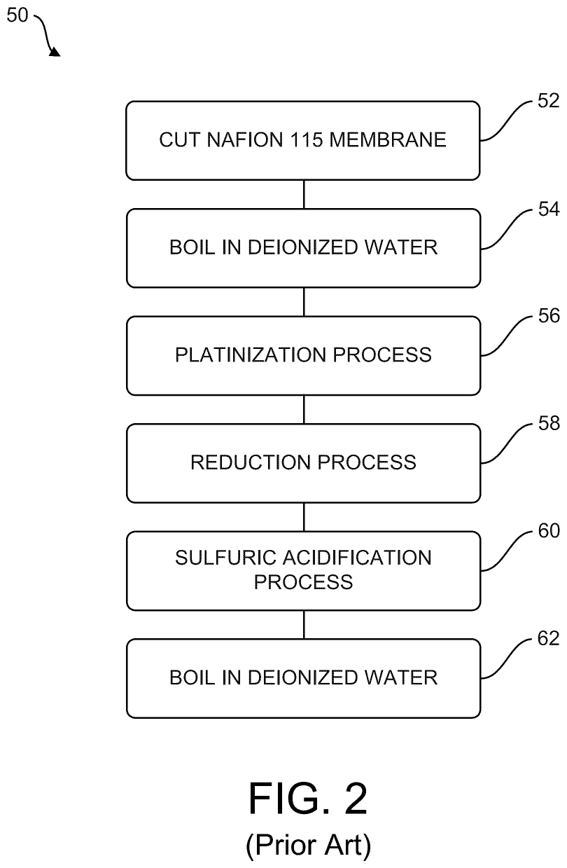

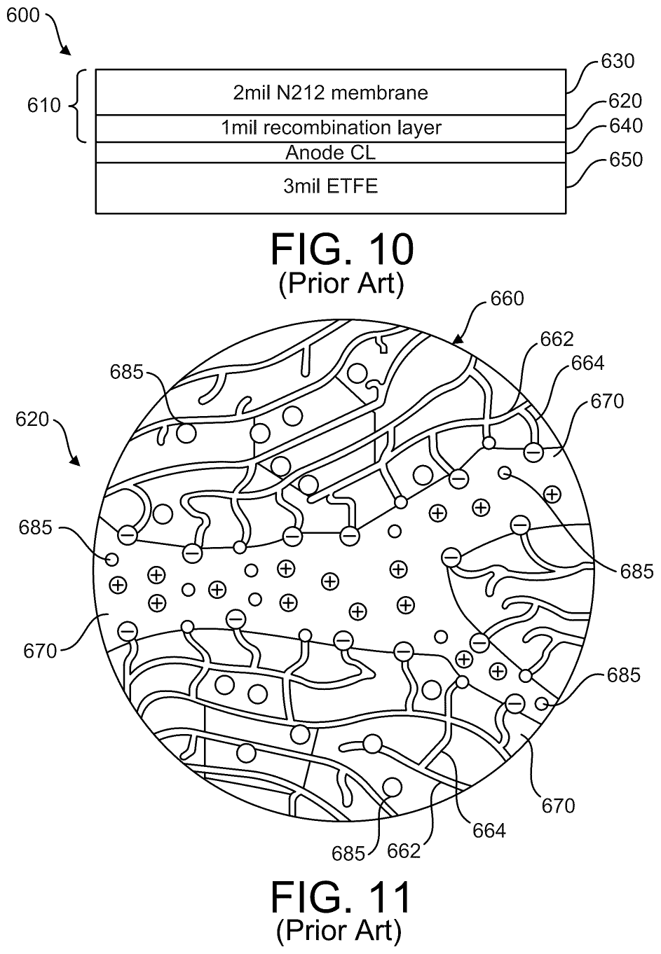

FIG. 10 illustrates a prior art bi-layer proton exchange membrane coated anode decal 600. For example, decal 600 may include a bi-layer proton exchange membrane 610 having a recombination layer 620 and a membrane layer 630, disposed on an anode 640 and a support 650. Prior art bi-layer proton exchange membrane 610 may include recombination layer 620 having a platinum particles and formed by the prior art process shown in FIGS. 1 and 2 and described above. Membrane layer 630 may not include a catalyst.

FIG. 11 diagrammatically illustrates prior art recombination layer 620 includes an ionomer 660 having a network of a plurality of backbones 662 and side branches 664 (function groups), which define channels 670 or passageways for transfer of hydrogen protons during the electrolysis process. As shown in FIG. 11, Pt black 685 (e.g., non-crystalline and spherical in form) is randomly distributed throughout the whole network of recombination layer 620. As described above, during the forming of prior art recombination layer 620, the Pt black, which is platinum in the metal form, is combined with the ionomer dispersion and ball milled for 7 days resulting recombination layer 620 having the platinum metal randomly disposed throughout recombination layer 620. Specifically, the platinum metal is disposed in channels 670 of the ionomer and also outside channel 670 such as between the backbones 662 and the side branches of the ionomer 660.

It will be appreciated from the present disclosure that the present recombination layer provides advantages and benefits over the prior art recombination layer. For example, the forming of the present recombination layer reduces the time to 3 hours to 2 days, depending on reduction condition, compared to the forming of the prior art recombination layer requiring 7 days or more and in separate batches, which is time consuming and introduces additional labor costs. In addition, the present recombination layer reduces the amount of platinum needed as the platinum is tailored to being deposited in the channels of the ionomer where is it most effective for mitigation (the hydrogen passing through the channels) compared to the prior art recombination layer, which disperses platinum particles randomly and indiscriminately throughout the entire recombination layer. In the prior art recombination layer, the Pt black is randomly dispersed into the ionomer so the utility of the total platinum being active sites in the channels for mitigation is low. The present recombination layer may be sized thinner than the prior art recombination layer, which prior art recombination layer has a lower utility of the platinum requiring the thickness to be 1 mil or greater.

Further, the present recombination layer, which tailors the platinum to the channels result in less platinum being disposed adjacent to the high voltage anode compared to the prior art recombination layer where the additional platinum is oxidized by the high voltage on the anode. As platinum oxide is not operable to mitigate the hydrogen crossover, in the prior art PEM electrolyzer, the mitigation efficiency of the total platinum in the prior art recombination layer is low.

In addition, in the present disclosure, the platinum such as the platinum crystal may be selectively dispersed by the side chain of ionomers, which is the pathway of H₂, so the utility of Pt active sites is high. The platinum such as the platinum crystals are also insulated by the ionomer's backbone, so the oxidation of the platinum can be mitigated. The thickness of the recombination layer can be reduced from the required prior art 1.0 mil recombination layer to less than 1 mil. In other embodiments, the thickness of the recombination layer may be about 0.75 mil, about 0.5 mil, about 0.3 mil, about 0.25 mil, about 0.2 mil, between about 0.2 mil and less than about 1.0 mil, between about 0.2 mil and less than about 0.75 mil, between about 0.2 mil and less than about 0.5 mil, between about 0.2 mil and less than about 0.3 mil, between about 0.2 mil and less than about 0.25 mil, or other suitable thicknesses or ranges of thicknesses.

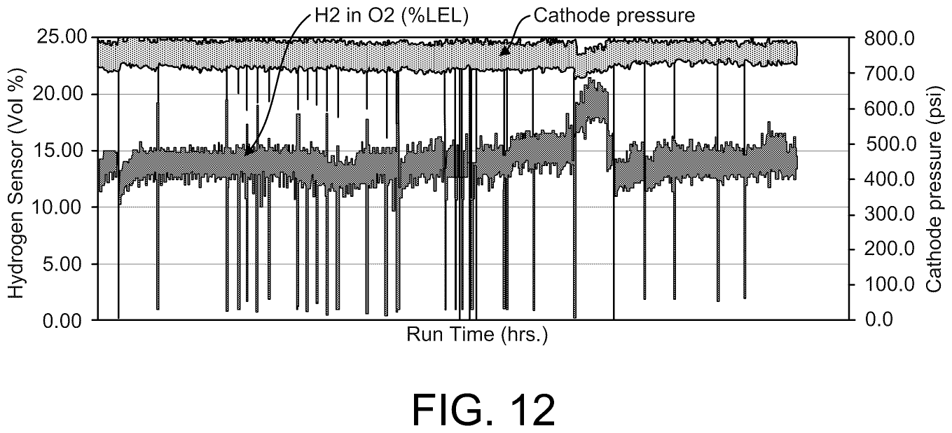

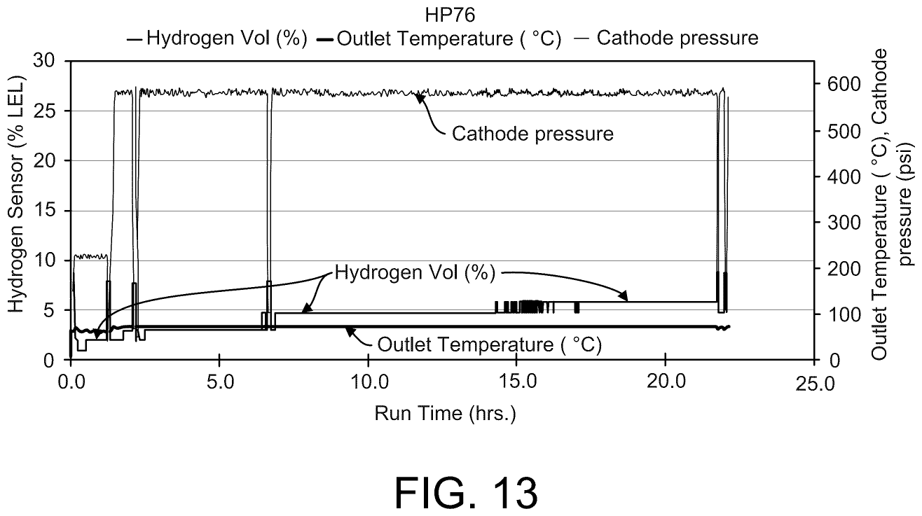

FIGS. 12 and 13 illustrate the results of a conventional prior art MEA electrolyzer (FIG. 12) having the recombination layer with Pt black throughout, and an MEA electrolyzer (FIG. 13) having the recombination layer of the present disclosure with the selectively distributed platinum nanocrystals.

In the MEAs, the half reaction taking place on the anode side of a PEM electrolyzer (Oxygen Evolution Reaction) is liquid water reactant is supplied to the catalyst where the supplied water is splitted to oxygen, protons and electrons. The half reaction taking place on the cathode side of a PEM electrolyzer (Hydrogen Evolution Reaction) is the supplied electrons and the protons that have conducted through the membrane are combined to create gaseous hydrogen. The oxygen side is at ambient (0 psi), the hydrogen side is run at 580 psi, and is separated by the proton exchange membrane. Permeation of hydrogen (H₂) from the cathode through the membrane to the anode can lead to the formation of explosive gas mixtures at the anode. The lower explosion limit (LEL) for H₂ in O₂ being about 4%.

FIG. 12 illustrates a graph of the results of the hydrogen crossover for a prior art MEA having a proton exchange member with the recombination layer formed by the process shown in FIGS. 1, 2, and 11 employing ball milling of PT black and an ionomer. As illustrated in FIG. 12, the hydrogen crossover (Hydrogen Sensor Volume % or H₂ in O₂% LEL) is about 16 percent of the LEL (4 percent) value. For example, by being determined with a hydrogen sensor disposed on the oxygen side.

FIG. 13 illustrates a graph of the results of the hydrogen crossover for the present disclosure or a MEA having a proton exchange member with the recombination layer formed by the process shown in FIGS. 4 and 12. As illustrated, the hydrogen crossover (Hydrogen Sensor % LEL) is about 6 percent of the of the LEL (4 percent) value, a reduction of about 63 percent reduction over the prior art. In addition, the crossover reduces the efficiency of the electrolyzer, thus the reduced LEL percentage results in an increased efficiency in the present MEA water electrolyzers. It may be possible that not all of the platinum salt is reduced and may remain in the channels of the ionomer. However, if any of the platinum salt does remain in the channels of the recombination layer, it appears not to be detrimental.

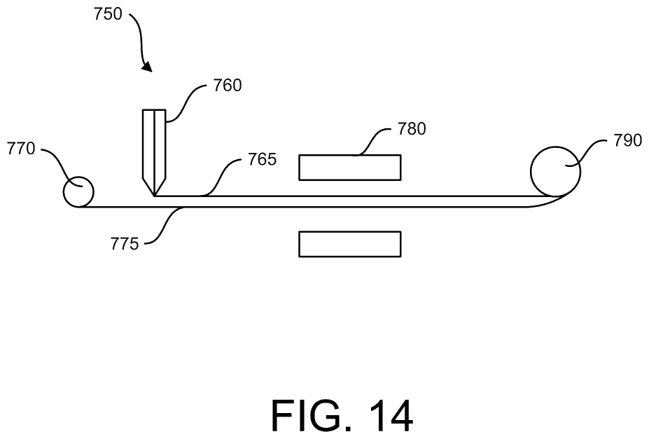

FIG. 14 illustrates a roll-to-roll process 700 for casting a recombination layer, according to an embodiment of the present disclosure. For example, in this embodiment, an ionomer dispersion may be prepared by adding platinum compound such as a platinum salt as shown in block 202 (FIG. 4), and maintaining the mixture in an environment such as shown in block 204 (FIG. 4), which may include pressurizing the mixture with a reactant to reduce the platinum compound.

For example, a depositor 760 may include a controllable flow rate and a controllable gap so that the depositor such as an injector or extruder may continuously deposit a layer 765 of the reduced mixture onto a moving substrate 775, which moving substrate is unwound from a roll 770. Layer 765 includes the mixture of the ionomer with a nanocrystal catalyst such as platinum nanocrystal. The dispersion may be deposed having a thickness of about 0.2 to about 1 mil, and the substrate may be polyimide backer film such as a 3 mil Kapton substrate, or a polyimide. In some embodiments, process 720 may employ one-pass or multiple passes to form the thickness of the resulting recombination layer 732. In addition, each pass may contain different loading or amounts (low to 0%) of Pt with different thickness of the deposited dispersion. The deposited dispersion may be cured or partially cured by passing through a drying step such as passing through a heater or furnace 280. The dry catalyst/ionomer layer 765 and substrate may be wound onto a roll 790.

For example, the recombination layer may then be laminated, e.g., hot press or roll-to roll process, to a PFSA (Nafion®, 3M™, Aquivion™, FORBLUE™, Donyue™, Hyproof™, Thinkre™, etc.) membrane that does not have platinum (Pt) incorporated therein. Cathode and anode electrodes may then be laminated to the prepared bi-layer membrane to form a MEA. For example, cathode and anode electrodes may be then laminated on the PFSA (Nafion®, 3M™, Aquivion™, FORBLUE™, Donyue™ Hyproof™, Thinkre™, etc.) membrane side and the recombination layer side of the bi-layer membrane, respectively, using a similar technique as the membrane lamination process, e.g., in a hot press or a roll-to-roll process.

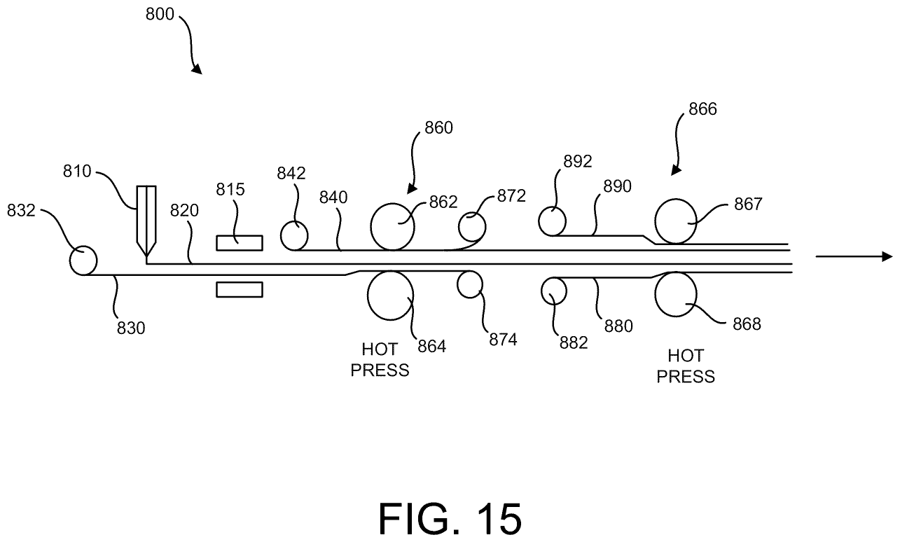

FIG. 15 illustrates a roll-to-roll process 800 for forming a MEA, for example, having a two-step lamination process, according to an embodiment of the present disclosure.

As illustrated in FIG. 15, a depositor 810 such as an injector or extruder may continuously deposit the mixture, as described above, for forming recombination layer 820 onto a moving first substrate 830, which moving substrate is unwound from a roll 832. The mixture 820 may include the ionomer with a nanocrystal catalyst such as platinum crystals as described above. The mixture may be deposed having a thickness of about 0.2 mil to about 1 mil, and the substrate may be a 3 mil Kapton substrate. After the mixture is cured or partially cured such as by passing through a heater, furnace or dryer 815, a membrane layer 840, for example, not having a catalyst and disposed on a backer on one side is unwound from a roll 842 and deposited on the cured or partially cured recombination layer 820. Membrane layer 840 may be a 2 mil N212 membrane.

The layers are assembled and pass through a first hot press 860 having, for example, a first heated roller 862 and a second heated roller 864. First substrate 830 is removed and wound onto a roller 874 and the substrate on NR212 membrane 840 is removed and wound on a roller 872. An anode electrode 880 is unwound from a roll 882 and deposited on or deposited adjacent to catalyst layer 820. A cathode electrode 890 is unwound from a roll 892 and deposited on or disposed adjacent to membrane 840. Anode electrode 880, catalyst layer 820, membrane layer 840 without a catalyst, and cathode electrode 890 pass through a second hot press 866, for example, having a first heated roller 867 and a second heated roller 868 to form a laminated MEA.

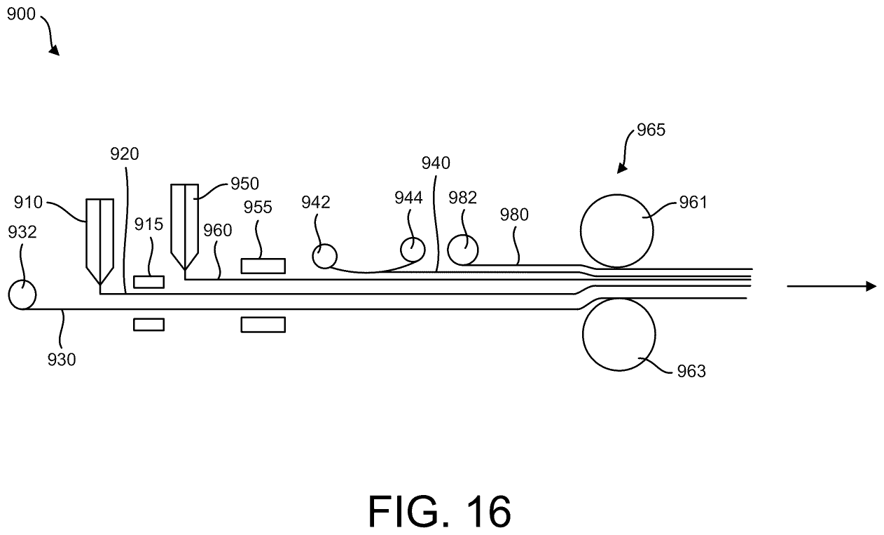

FIG. 16 illustrates a roll-to-roll process 900 for forming a MEA, for example, having a one-step lamination process, according to an embodiment of the present disclosure.

As illustrated in FIG. 16, a depositor 910 such as an injector or extruder may continuously deposit an anode electrode layer 920 onto a moving substrate 930. The deposited anode electrode layer and substrate may pass through a dryer 915. A depositor 950 such as an injector or extruder may continuously deposit a recombination layer 960 such as described above onto a moving anode electrode layer 920 and first substrate 930, which substrate is unwound from a roll 932, respectively. The recombination layer 960 may include the ionomer with a nanocrystal catalyst such as platinum. The recombination layer may be deposed having a thickness of about 0.2 mil to 1.0 mil, and substrate 930 may be a 3 mil ETFE substrate. The deposited recombination layer 960 may pass through a dryer 955. After the recombination layer is cured or partially cured, a membrane layer 940 not having a catalyst with a backer or second substrate on one side is unwound from a roll 942 and deposited on the cured or partially cured recombination layer 960, the backer being removed on a roll 944. The backing layer 940 may be a 2 mil N212 membrane, and the second substrate or backing layer may be a 3 mil mylar layer. A cathode electrode 990 is unwound from a roll 982 and deposited on or deposited adjacent to membrane 940. The layers are assembled and may pass through a hot press 965 having, for example, a first heated roller 961 and a second heated roller 963 to form a laminated structure for an MEA.

In other embodiments, the dispersion may be cast into a thin membrane on a carrier substrate to form the recombination layer. For example, the reduced mixture may be then coated on a substrate such as polyimide (Kapton) film using a doctor blade film applicator. Multiple layers of casting are performed as needed until, for example, a 0.2 mil to 1.0 mil recombination layer thickness is achieved.

It will be appreciated that the proton exchange membranes may include solely a bi-layer proton exchange membrane or a bi-layer membrane with additional membrane layers. In an electrolyzer with low-pressure oxygen and high-pressure hydrogen, hydrogen will permeate more quickly, and therefore the platinum recombination catalyst is preferable near the anode electrode. Similarly, in a high-pressure oxygen configuration the Pt/ionomer layer or recombination catalyst will preferably be closer to the hydrogen (cathode) side of the MEA.

As will be appreciated from the present description, the techniques of the present disclosure for forming, for example, bi-layer membranes have demonstrated the capability of forming PEM electrolyzer MEA fabrication using a platinum salt without sacrificing performance compared to conventional processes. The dry processes may save on total capital cost for PEM electrolyzer fabrication by replacing labor-intensive and time-consuming platinization process with a mitigation layer casting and dry lamination processes. In addition to the labor cost, the bi-layer membrane design will also save on material cost. The amount of platinum recombination catalyst in the membrane may be substantially reduced by applying the catalyst in a 0.2 mil to about a 1.0 mil layer of the membrane close to the anode catalyst layer instead of inefficiently distributing the recombination catalyst throughout the whole membrane. As described below, in some embodiments, a thin layer of platinum crystal nanoparticles may be attached such as laminated on top of the PFSA (Nafion®, 3M™, Aquivion™ FORBLUE™, Donyue™, Hyproof™, Thinkre™, etc.) membrane to replace the traditional platinum doping in the whole membrane. Such processes may reduce the amount of platinum used in the membrane (for example, about 1 wt. % to about 5 wt. %), but may also improve the durability and reliability of the PEMWE devices.

The proton exchange membranes may have two different layers, and formed by the fabrication process described above or other suitable processes. It will be appreciated that the proton exchange membranes may have more than two distinct layers wherein two of the layers provide an interface between the layers having differing catalyst content such as member layer having less catalyst or no catalyst compared to the recombination layer having a catalyst or greater catalyst content. In some embodiments, a total thickness of recombination layer may be between about 1 percent and about 15 percent of the thickness of the whole membrane, between about 5 percent and about 10 percent of the thickness of the whole membrane, no more than about 15 percent of the thickness of the whole membrane, no more than about 10 percent of the thickness of the whole membrane, or other suitable thickness. For example, in other embodiments, a total thickness of recombination layer may be about 100 percent, about 75 percent, about 50 percent, or about 25 percent. In still other embodiments, a total thickness of recombination layer may be between about 1 percent and about 100 percent thickness of the whole membrane, between about 5 percent or about 10 percent or about 15 percent and about 100 percent thickness of the whole membrane, between about 1 percent and about 75 percent of the thickness of the whole membrane, between about 5 percent or about 10 percent or about 15 percent and about 75 percent thickness of the whole membrane, between about 1 percent and about 50 percent of the thickness of the whole membrane, between about 5 percent or about 10 percent or about 15 percent and about 50 percent thickness of the whole membrane, between about 1 percent and about 25 percent of the thickness of the whole membrane, between about 5 percent or about 10 percent or about 15 percent and about 25 percent thickness of the whole membrane.

As will be appreciated, the present configuration of the bi-layer proton exchange membrane in an MEA electrolyzer may include avoiding the need for hydrogen pumps and/or mitigating the H₂ crossover to reduce safety hazard, and be desirable for high pressure large scale water electrolyzer cells. Hydrogen is often purified and/or compressed so that it can be stored for usage. Hydrogen pumps have been used for hydrogen purification and/or compression of hydrogen rich gas. Currently, high pressure storage is required to improve the energy density of hydrogen fuel. The present disclosure allows for efficiently directly pressurizing the H₂ from the electrolysis process compared to using downstream mechanical compressors, as well reducing the likelihood of H₂ crossover as described above.

As may be recognized by those of ordinary skill in the art based on the teachings herein, numerous changes and modifications may be made to the above-described and other embodiments of the present disclosure without departing from the scope of the disclosure. The components of the recombination layer, proton exchange membrane, and MEAs as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the MEAs may include more or fewer components or features than the embodiments as described and illustrated herein. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. A recombination layer comprising:
an ionomer;
a nanocrystal catalyst disposed in the ionomer.

2. The recombination layer of claim 1, wherein:
the nanocrystal catalyst is greater in the channels of the ionomer compared to in the side chains of the ionomer.

3. The recombination layer of claim 1, wherein:
the nanocrystal catalyst comprises platinum crystal.

4. The recombination layer of claim 1, wherein:
the nanocrystal catalyst is based on tetraamine platinum hydroxide, tetraammineplatinum (II) chloride, and/or platinum diamino dinitro nitrate,

5. The recombination layer of claim 1, wherein:
the recombination layer comprises a thickness of between 0.2 mil and 1 mil.

6. The recombination layer of claims of claim 1, further comprising:
a substrate; and
the recombination layer is disposed on the substrate.

7. A proton exchange membrane comprising:
the recombination layer of claim 1 having a thickness;
a membrane layer;
a catalyst content in the recombination layer being greater than a catalyst content in the membrane layer; and
the exchange membrane having an interface between the recombination layer and the membrane layer.

8. The proton exchange membrane of claim 7, wherein:
the recombination layer comprises a thickness of between 0.2 mil and 1 mil; and
the membrane layer comprises a thickness between 1.5 mil to 2 mil.

9. The proton exchange membrane of claim 7, wherein the membrane layer comprises the membrane layer without a catalyst.

10. The proton exchange membrane of claim 7, further comprising:
a substrate;
an anode electrode disposed on the substrate; and
the proton exchange membrane disposed on the anode electrode.

11. The proton exchange membrane of claim 7, further comprising:
a first substrate;
a second substrate;
the proton exchange membrane disposed between the substrates; and
wherein the proton exchange membrane comprises the proton exchange membrane disposed on a roll.

12. A membrane electrode assembly comprising:
the proton exchange membrane of claim 1;
an anode electrode disposed on the recombination layer; and
a cathode electrode disposed on the membrane layer.

13. The membrane electrode assembly of claim 12, wherein:
the recombination layer comprises a thickness of between 0.2 mil and 1 mil, and the proton exchange membrane comprises a thickness between 1 mil and 3 mil.

14. A method for electrolyzing water, the method comprising:
providing the membrane electrode assembly of claim 12; and
applying a voltage potential across the cathode electrode and the anode electrode to produce hydrogen.

15. A method comprising:
providing an ionomer dispersion;
providing a compound comprising a catalyst having a charge;
adding the compound to the ionomer to form a mixture;
reducing the catalyst in the compound to a metal catalyst in the ionomer; and
forming the mixture with the catalyst having the metal catalyst into a recombination layer for a proton exchange membrane.

16. The method of claim 15, wherein:
the reducing comprises forming a nanocrystal catalyst.

17. The method of claim 16, wherein:
the nanocrystal catalyst is greater in the channels of the ionomer compared to outside the channels of the ionomer.

18. The method of claim 15, wherein:
the compound comprises a platinum salt.

19. The method of claim 18, wherein:
the compound comprises tetraamine platinum hydroxide;

20. The method of claim 15, wherein:
the reducing comprises pressurizing the mixture with the reactant for only 2 days.

21. The method of claim 15, wherein:
the reducing comprises pressurizing the mixture with the reactant for only 3 hours.

22. The method of claim 15, wherein:
the adding comprises adding the compound to the ionomer in a ratio of 96.5 g 6.22% of tetraamine platinum hydroxide to 1,000 grams of the ionomer dispersion.

23. The method of claim 22, wherein:
the reducing comprises pressurizing the mixture in 5% H₂ in argon at 200 psi at 86 Celsius for 2 days; or
the reducing comprises purging with 5% H₂ in argon with a constant flow rate at 86 Celsius for 3 hours.

24. The method of claim 15, further comprising:
providing a membrane layer having a first thickness;
providing the recombination layer having a second thickness, the catalyst content in the recombination layer being greater or equal than a catalyst content in the membrane layer; and
forming the membrane layer and the recombination layer into a proton exchange membrane having an interface between the membrane layer and the recombination layer.

25. The method of claim 24, wherein:
the membrane layer comprises a thickness of at least 1.5 mil to 2 mil, and
the recombination layer comprises a thickness between 0.2 mil to less than 1 mil.

26. The method of claim 25, wherein:
the recombination layer comprises a thickness between 0.2 mil to 0.5 mil.

27. The method of claim 24, wherein:
the providing the membrane layer comprises providing the membrane layer without a catalyst.

28. The method of claim 24, wherein the forming comprises:
laminating the membrane layer to the recombination layer to form the proton exchange membrane; or
hot pressing the membrane layer to the recombination layer to form the proton exchange membrane.

29. The method of claim 24, wherein:
the providing the recombination layer comprises a roll-to-roll process of depositing the mixture on a moving substrate; and/or
the forming the membrane layer comprises a roll-to-roll process of depositing the membrane layer on the recombination layer.

30. The method of claim 24, wherein:
the proton exchange membrane comprises a bi-layer proton exchange membrane.

31. The method of claim 24, further comprising:
providing an anode electrode;
providing a cathode electrode; and
forming the anode electrode, the cathode electrode, and the proton exchange membrane into a membrane electrode assembly.

32. A method for electrolyzing water, the method comprising:
providing the membrane electrode assembly of claim 31; and
applying a voltage potential across the cathode electrode and the anode electrode to produce hydrogen.
